(19) United States
(12) Patent Application Publication
(10) Pub. No.: US 2021/0050564 A1
(43) Pub. Date: Feb. 18, 2021

(54) BATTERY CELL AND BATTERY PACK

(71) Applicant: Envision AESC Energy Devices Ltd., Sagamihara-shi, Kanagawa (JP)

(72) Inventors: Yoshimasa YAMAMOTO, Sagamihara-shi (JP); Yoshiki KOBAYASHI, Sagamihara-shi (JP)

(73) Assignee: Envision AESC Energy Devices Ltd., Sagamihara-shi, Kanagawa (JP)

(21) Appl. No.: 16/965,872

(22) PCT Filed: Jan. 10, 2019
(86) PCT No.: PCT/JP2019/000479

§ 371 Date: Jul. 29, 2020

(30) Foreign Application Priority Data
Jan. 30, 2018 (JP) 2018-013971

(51) Int. Cl. H01M 2/06; H01M 10/0585; H01M 2/30; H01M 2/02; H01M 2/10; H01M 10/0525

(52) U.S. Cl. CPC H01M 2/06; H01M 10/0585; H01M 2/30; H01M 2/1077; H01M 2/1061; H01M 10/0525; H01M 2/0267

(57) ABSTRACT

A first lead terminal (210) has a first end (212) and a second end (214). The second end (214) is opposite to the first end (212). The first lead terminal (210) is positioned such that the first end (212) of the first lead terminal (210) faces a first side surface (104a) of a laminated body (100). The second end (214) of the first lead terminal (210) projects obliquely with respect to the first side surface (104a) of the laminated body (100). The first lead terminal (210) has a bent portion (C) along a longitudinal direction of the first lead terminal (210) between the first end (212) and the second end (214), more specifically, outside an exterior material (140).

### TECHNICAL FIELD

The present invention relates to a battery cell and a battery pack.

### BACKGROUND ART

In recent years, non-aqueous electrolyte secondary batteries, especially lithium ion secondary batteries have been developed. In a lithium ion secondary battery, a battery module may be configured of a plurality of stacked battery cells. Each battery cell includes a positive electrode, a negative electrode, a separator, an exterior material, and a lead terminal. The positive electrode, the negative electrode, and the separator configure a laminated body, and are laminated such that the adjacent positive electrode and negative electrode are separated from each other by the separator. The laminated body is wrapped with the exterior material. The lead terminal is positioned such that one end of the lead terminal is located inside the exterior material and the other end of the lead terminal is exposed to the outside of the exterior material.

Patent Documents 1 to 3 describe bending of lead terminals. According to Patent Documents 1 and 2, the lead terminal is bent outside an exterior material. According to Patent Document 3, the lead terminal is bent inside an exterior material.

### RELATED DOCUMENT

### Patent Document

[Patent Document 1] Japanese Laid-Open Patent Publication No. 2014-504780
[Patent Document 2] Japanese Laid-Open Patent Publication No. 2003-323883
[Patent Document 3] Japanese Laid-Open Patent Publication No. 2000-200586

### SUMMARY OF THE INVENTION

### Technical Problem

In the battery cell, one end of the lead terminal may face an internal member (for example, a laminated body) of the battery cell. The present inventor has found that impact may cause the lead terminal to pierce the internal member of the battery cell.

An object of the present invention is to restrain piercing of a lead terminal to an internal member of a battery cell.

### Solution to Problem

According to the present invention, there is provided a battery cell comprising:
a laminated body comprising a first electrode, a second electrode, and a separator, the laminated body comprising a first surface, a second surface opposite to the first surface, and a first side surface between the first surface and the second surface; and
a first lead terminal comprising a first end and a second end opposite to the first end, the first end being positioned such that the first end faces the first side surface of the laminated body,
wherein the second end of the first lead terminal projects obliquely with respect to the first side surface of the laminated body.

According to the present invention, there is provided a battery pack comprising:
a case; and
a battery cell accommodated in the case;
wherein the battery cell comprises:
a laminated body comprising a first electrode, a second electrode, and a separator, the laminated body comprising a first surface, a second surface opposite to the first surface, and a first side surface between the first surface and the second surface, and
a first lead terminal comprising a first end and a second end opposite to the first end, the first end being positioned such that the first end faces the first side surface of the laminated body, and
the second end of the first lead terminal projects obliquely with respect to the first side surface of the laminated body.

### Advantageous Effects of Invention

According to the present invention, it is possible to restrain piercing of the lead terminal into the internal member of the battery cell.

### BRIEF DESCRIPTION OF THE DRAWINGS

The aforementioned object and other objects, features, and advantages will become further apparent through the preferred embodiments described below and the following drawings accompanying the embodiments.

FIG. 1 is a top view of a battery cell according to a first embodiment.

FIG. 2 is a sectional view taken along A-A in FIG. 1.

FIG. 3 is a sectional view taken along B-B in FIG. 1.

FIG. 4 is a diagram illustrating a modification example of FIG. 2.

FIG. 5 is a top view of a battery cell according to a second embodiment.

FIG. 6 is a sectional view taken along C-C in FIG. 5.

FIG. 7 is a sectional view taken along D-D in FIG. 5.

FIG. 8 is a sectional view of a battery cell according to a third embodiment.

FIG. 9 is an enlarged top view of a part of the battery cell illustrated in FIG. 8.

FIG. 10 is a side view of a battery pack according to a fourth embodiment.

FIG. 11 is a front view of the battery pack illustrated in FIG. 10.

### DESCRIPTION OF EMBODIMENTS

Hereinafter, embodiments of the present invention will be described with reference to the drawings. In all the drawings, the same reference signs will be applied to similar components, and description thereof will not be repeated.

### First Embodiment

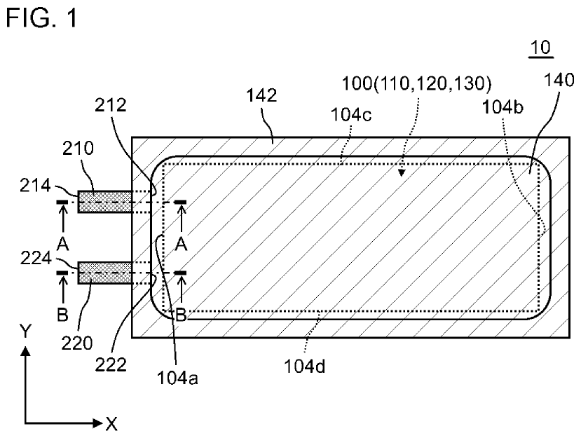

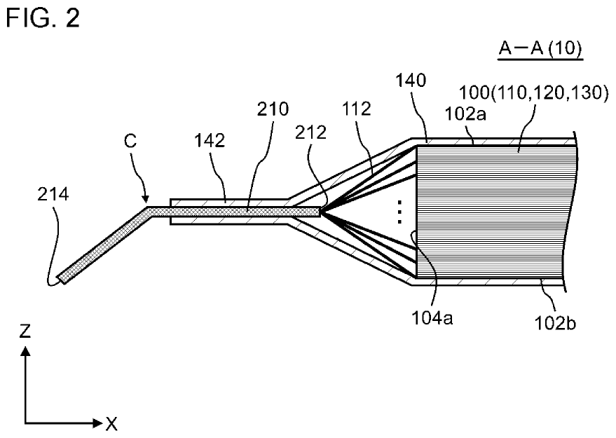

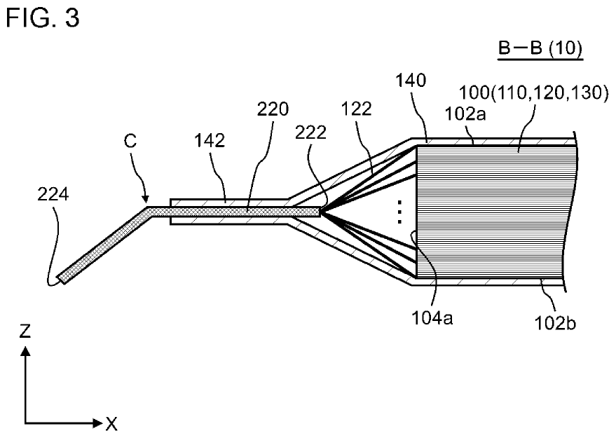

FIG. 1 is a top view of a battery cell 10 according to a first embodiment. FIG. 2 is a sectional view taken along A-A in FIG. 1. FIG. 3 is a sectional view taken along B-B in FIG. 1.

An outline of the battery cell 10 will be described with reference to FIG. 2. The battery cell 10 includes a laminated body 100 and a first lead terminal 210. The laminated body 100 includes a first electrode 110, a second electrode 120, and a separator 130. The laminated body 100 has a first surface 102a, a second surface 102b, and a first side surface 104a. The second surface 102b is opposite to the first surface 102a. The first side surface 104a is between the first surface 102a and the second surface 102b. The first lead terminal 210 has a first end 212 and a second end 214. The second end 214 is opposite to the first end 212. The first lead terminal 210 is positioned such that the first end 212 of the first lead terminal 210 faces the first side surface 104a of the laminated body 100. The second end 214 of the first lead terminal 210 projects obliquely with respect to the first side surface 104a of the laminated body 100. In the example illustrated in FIG. 2, in particular, the first lead terminal 210 has a bent portion C along the longitudinal direction of the first lead terminal 210 between the first end 212 and the second end 214, more specifically, outside an exterior material 140 (which will be described later in detail).

According to the aforementioned configuration, it is possible to restrain piercing of the first lead terminal 210 into an internal member (for example, the laminated body 100) of the battery cell 10. Specifically, in the aforementioned configuration, the second end 214 of the first lead terminal 210 projects obliquely with respect to the first side surface 104a of the laminated body 100. Accordingly, even if the second end 214 of the first lead terminal 210 receives impact, the force transmitted from the first end 212 of the first lead terminal 210 to the internal member of the battery cell 10, especially to the laminated body 100 can be lessened. Accordingly, it is possible to restrain piercing of the first lead terminal 210 into the internal member (for example, the laminated body 100) of the battery cell 10.

In the example illustrated in FIG. 3 as well, it is similarly possible to restrain piercing of a second lead terminal 220 into the internal member (for example, the laminated body 100) of the battery cell 10. The second lead terminal 220 has a first end 222 and a second end 224. The second end 224 is opposite to the first end 222. The second lead terminal 220 is positioned such that the first end 222 of the second lead terminal 220 faces the first side surface 104a of the laminated body 100. The second end 224 of the second lead terminal 220 projects obliquely with respect to the first side surface 104a of the laminated body 100. In the example illustrated in FIG. 3, in particular, the second lead terminal 220 has a bent portion C along the longitudinal direction of the second lead terminal 220 between the first end 222 and the second end 224, more specifically, outside the exterior material 140 (which will be described later in detail). Accordingly, it is possible to restrain piercing of the second lead terminal 220 into the internal member (for example, the laminated body 100) of the battery cell 10.

Details of the battery cell 10 will be described with reference to FIGS. 1 to 3.

The battery cell 10 includes the laminated body 100, a plurality of first tabs 112, a plurality of second tabs 122, the exterior material 140, the first lead terminal 210, and the second lead terminal 220.

In the example illustrated in FIGS. 1 to 3, the laminated body 100 includes a plurality of first electrodes 110, a plurality of second electrodes 120, and a plurality of separators 130. In another example, each of the number of the first electrodes 110, the number of the second electrodes 120, and the number of the separators 130 included in the laminated body 100 may be only one. The first electrodes 110 and the second electrodes 120 have different polarities and may be positive electrodes and negative electrodes, respectively, or may be negative electrodes and positive electrodes, respectively. The first electrodes 110, the second electrodes 120, and the separators 130 are stacked in one direction (the Z direction in the drawing) such that the adjacent first electrodes 110 and second electrodes 120 are separated by the separators 130.

The laminated body 100 has a substantially rectangular parallelepiped shape. The laminated body 100 has a first surface 102a, a second surface 102b, a first side surface 104a, a second side surface 104b, a third side surface 104c, and a fourth side surface 104d. The second surface 102b is opposite to the first surface 102a. The first side surface 104a is between the first surface 102a and the second surface 102b. The second side surface 104b is opposite to the first side surface 104a. The third side surface 104c is between the first side surface 104a and the second side surface 104b. The fourth side surface 104d is between the third side surfaces 104c. The laminated body 100 has a thickness (the Z direction in the drawing) between the first surface 102a and the second surface 102b, has a length (the X direction in the drawing) between the first side surface 104a and the second side surface 104b, and has a width (the Y direction in the drawing) between the third side surface 104c and the fourth side surface 104d. In the example illustrated in FIG. 1, the length of the laminated body 100 (the X direction in the drawing) is greater than the width of the laminated body 100 (the Y direction in the drawing).

As illustrated in FIG. 2, the plurality of first tabs 112 projects from the laminated body 100. One end of each of the plurality of first tabs 112 is connected to each of the plurality of first electrodes 110 in the laminated body 100. The other ends of the plurality of first tabs 112 are bundled at the first lead terminal 210. The plurality of first electrodes 110 can be electrically connected to a member outside the exterior material 140 via the plurality of first tabs 112 and the first lead terminal 210.

As illustrated in FIG. 3, the plurality of second tabs 122 projects from the laminated body 100. One end of each of the plurality of second tabs 122 is connected to each of the plurality of second electrodes 120 in the laminated body 100. The other ends of the plurality of second tabs 122 are bundled at the second lead terminal 220. The plurality of second electrodes 120 can be electrically connected to a member outside the exterior material 140 via the plurality of second tabs 122 and the second lead terminal 220.

The exterior material 140 wraps the laminated body 100 and seals the laminated body 100, the plurality of first tabs 112, the plurality of second tabs 122, a part of the first lead terminal 210, and a part of the second lead terminal 220. The exterior material 140 also accommodates an electrolytic solution (not illustrated). In the example illustrated in FIG. 2, the exterior material 140 seals a part of the first lead terminal 210 such that the first end 212 of the first lead terminal 210 is positioned inside the exterior material 140 and the second end 214 of the first lead terminal 210 is exposed to the outside of the exterior material 140. In the example illustrated in FIG. 3, the exterior material 140 seals a part of the second lead terminal 220 such that the first end 222 of the second lead terminal 220 is positioned inside the exterior material 140 and the second end 224 of the second lead terminal 220 is exposed to the outside of the exterior material 140.

In the example illustrated in FIG. 1, the exterior material 140 has a sealing portion 142. The sealing portion 142 is formed by welding of the exterior material 140, for example. The sealing portion 142 continuously extends along the first side surface 104a, the third side surface 104c, the second side surface 104b, and the fourth side surface 104d of the laminated body 100. Thus, the laminated body 100 is sealed by the exterior material 140.

The first lead terminal 210 has a bent portion C between the first end 212 and the second end 214, particularly outside the exterior material 140 in the example illustrated in FIG. 2. In the example illustrated in FIG. 2, the bent portion C has a large curvature, and the first lead terminal 210 is thus bent at substantially one point (bent portion C) outside the exterior material 140. Thus, the second end 214 of the first lead terminal 210 projects obliquely with respect to the first side surface 104a of the laminated body 100. Accordingly, even if the second end 214 of the first lead terminal 210 receives impact, the force transmitted from the first end 212 of the first lead terminal 210 to the internal member of the battery cell 10, especially to the laminated body 100 is lessened.

The second lead terminal 220 has a bent portion C between the first end 222 and the second end 224, particularly outside the exterior material 140 in the example illustrated in FIG. 3. In the example illustrated in FIG. 3, the bent portion C has a large curvature, and the second lead terminal 220 is thus bent at substantially one point (bent portion C) outside the exterior material 140. Thus, the second end 224 of the second lead terminal 220 projects obliquely with respect to the first side surface 104a of the laminated body 100. Accordingly, even if the second end 224 of the second lead terminal 220 receives impact, the force transmitted from the first end 222 of the second lead terminal 220 to the internal member of the battery cell 10, especially to the laminated body 100 is lessened.

In the example illustrated in FIGS. 1 to 3, the battery cell 10 includes both the first lead terminal 210 and the second lead terminal 220 on one of both sides of the exterior material 140 in the length direction of the laminated body 100 (the X direction in the drawing). The first lead terminal 210 and the second lead terminal 220 are aligned in the width direction of the laminated body 100 (the Y direction in the drawing). Spacing the first lead terminal 210 and the second lead terminal 220 by an appropriate distance can prevent contact between the first lead terminal 210 and the second lead terminal 220, that is, short-circuiting between the first lead terminal 210 and the second lead terminal 220.

In the example illustrated in FIGS. 2 and 3, the first lead terminal 210 and the second lead terminal 220 are bent in the same direction (downward in the Z direction in the drawings). In another example, the first lead terminal 210 and the second lead terminal 220 may be bent in different directions. In one example, the first lead terminal 210 may be bent upward while the second lead terminal 220 may be bent downward.

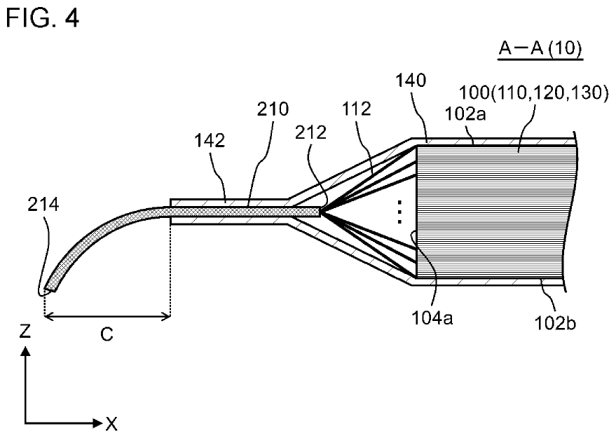

FIG. 4 is a diagram illustrating a modification example of FIG. 2.

The first lead terminal 210 has a bent portion C along the longitudinal direction of the first lead terminal 210 between the first end 212 and the second end 214, more specifically, outside the exterior material 140. In the example illustrated in FIG. 4, the bent portion C has a small curvature, and the first lead terminal 210 is thus curved from the end of the sealing portion 142 to the second end 214. Thus, the second end 214 of the first lead terminal 210 projects obliquely with respect to the first side surface 104a of the laminated body 100. Accordingly, even if the second end 214 of the first lead terminal 210 receives impact, the force transmitted from the first end 212 of the first lead terminal 210 to the internal member of the battery cell 10, especially to the laminated body 100 is lessened.

### Second Embodiment

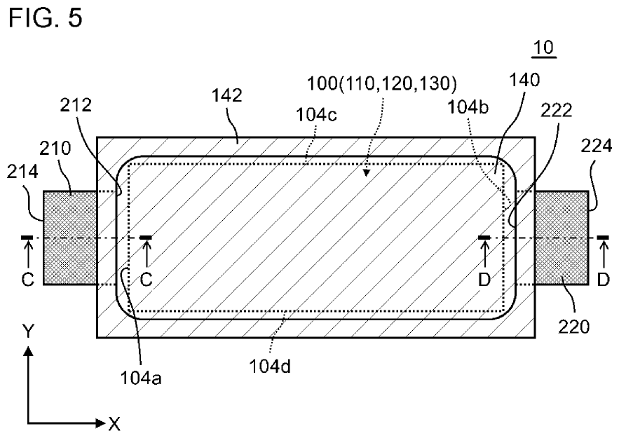

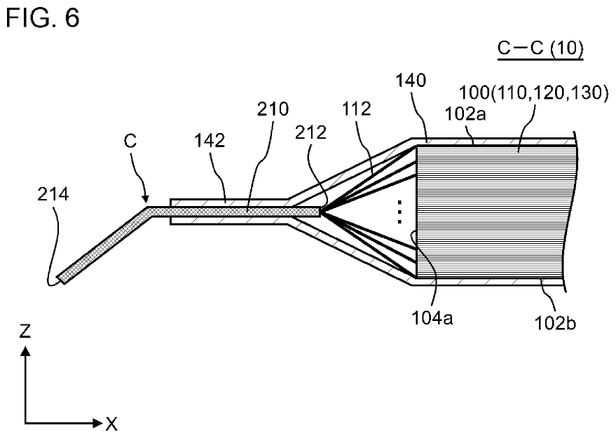

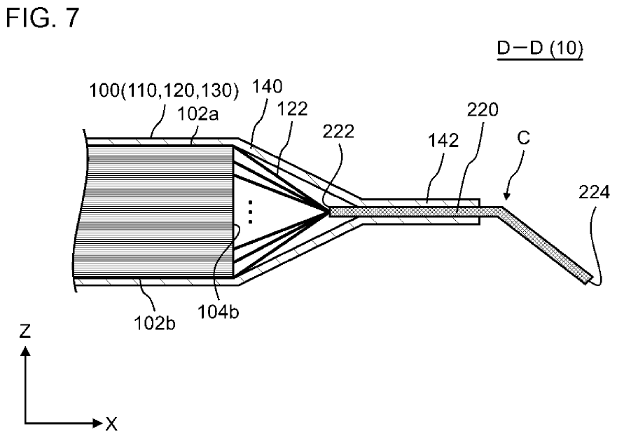

FIG. 5 is a top view of a battery cell 10 according to a second embodiment and corresponds to FIG. 1 of the first embodiment. FIG. 6 is a sectional view taken along C-C in FIG. 5. FIG. 7 is a sectional view taken along D-D in FIG. 5. The battery cell 10 according to this embodiment is similar to the battery cell 10 according to the first embodiment except for the following points.

In the example illustrated in FIGS. 5 to 7, the battery cell 10 has a first lead terminal 210 on one of both sides of an exterior material 140 in the length direction (the X direction in the drawing) of a laminated body 100 and has a second lead terminal 220 on the other side of both sides of the exterior material 140 in the length direction of the laminated body 100 (the X direction in the drawing). Accordingly, it is possible to space the first lead terminal 210 and the second lead terminal 220 by a long distance and to prevent contact between the first lead terminal 210 and the second lead terminal 220, that is, short-circuiting between the first lead terminal 210 and the second lead terminal 220. As illustrated in FIG. 6, the first lead terminal 210 is positioned such that a first end 212 faces a first side surface 104a of the laminated body 100. As illustrated in FIG. 7, the second lead terminal 220 is positioned such that a first end 222 faces a second side surface 104b of the laminated body 100.

In the example illustrated in FIG. 6, a second end 214 of the first lead terminal 210 projects obliquely with respect to the first side surface 104a of the laminated body 100, similarly to the example illustrated in FIG. 2. Accordingly, it is possible to restrain piercing of the first lead terminal 210 into the internal member (for example, the laminated body 100) of the battery cell 10.

In the example illustrated in FIG. 7, the second end 214 of the first lead terminal 210 projects obliquely with respect to the second side surface 104b of the laminated body 100, similarly to the example illustrated in FIG. 3. Accordingly, it is possible to restrain piercing of the second lead terminal 220 into the internal member (for example, the laminated body 100) of the battery cell 10.

### Third Embodiment

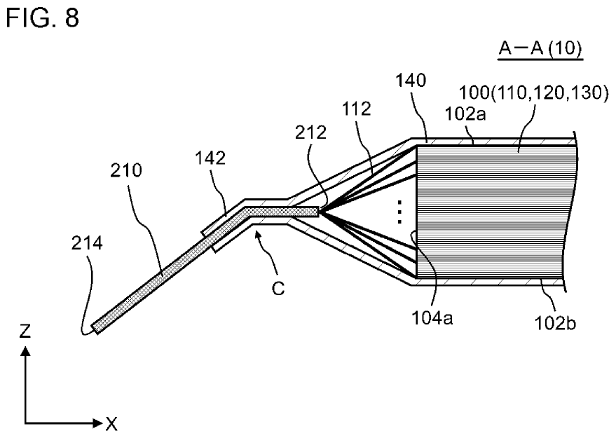

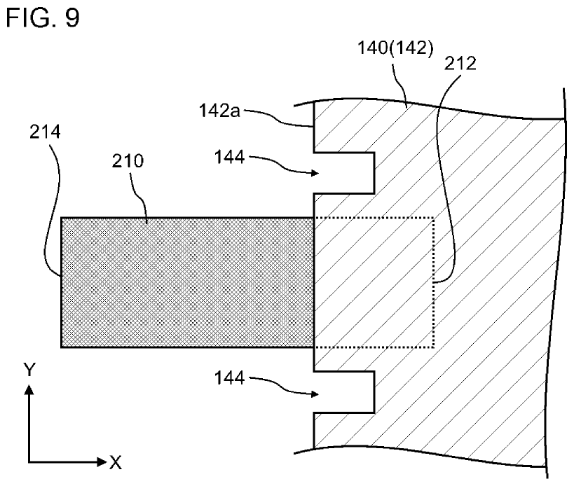

FIG. 8 is a sectional view of a battery cell 10 according to a third embodiment and corresponds to FIG. 2 of the first embodiment. FIG. 9 is an enlarged top view of a part of the battery cell 10 illustrated in FIG. 8. The battery cell 10 according to this embodiment is similar to the battery cell 10 according to the first embodiment except for the following points.

A part of a first lead terminal 210 is sealed by an exterior material 140, and the first lead terminal 210 has a bent portion C at this part of the first lead terminal 210. Accordingly, the part of the exterior material 140 is bent together with the first lead terminal 210.

In the example illustrated in FIG. 9, the exterior material 140 has a first side 142a. The first side 142a intersects the first lead terminal 210. The sealing portion 142 of the exterior material 140 has notch on at least one of both sides of the first lead terminal 210, and in the example illustrated in FIG. 9, in particular, the sealing portion 142 has notches 144 on both sides of the first lead terminal 210. The notch 144 facilitates bending of the exterior material 140 together with the first lead terminal 210.

The structure of the first lead terminal 210 and its periphery illustrated in FIGS. 8 and 9 can also be applied to the structure of the second lead terminal 220 and its periphery.

### Fourth Embodiment

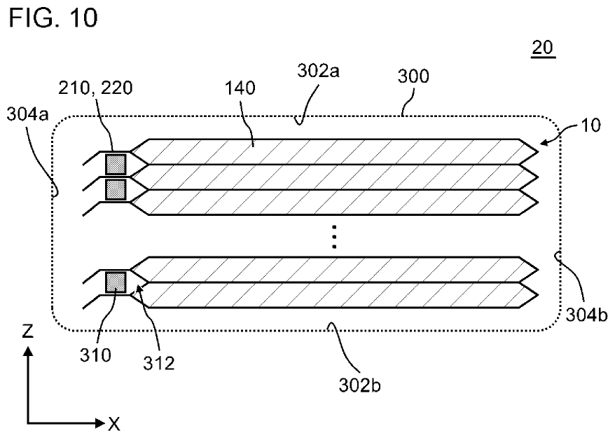

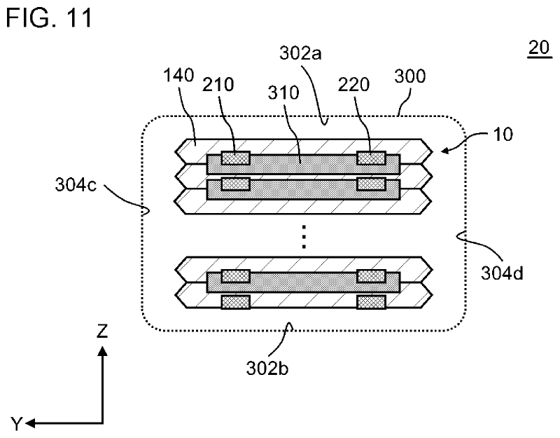

FIG. 10 is a side view of a battery pack 20 according to a fourth embodiment. FIG. 11 is a front view of the battery pack 20 illustrated in FIG. 10. In FIGS. 10 and 11, a member inside a case 300 (for example, battery cells 10) is seen through the case 300 for explanation.

The battery pack 20 includes the plurality of battery cells 10 and the case 300.

Each battery cell 10 is similar to the battery cell 10 according to any one of the first to third embodiments, and in the example illustrated in FIGS. 10 and 11, in particular, each battery cell 10 is similar to the battery cell 10 illustrated in FIGS. 1 to 3. The plurality of battery cells 10 are laminated in one direction (the Z direction in the drawing).

The case 300 has an internal space having a substantially rectangular parallelepiped shape. The internal space of the case 300 is defined by a first inner surface 302a, a second inner surface 302b, a first inner side surface 304a, a second inner side surface 304b, a third inner side surface 304c, and a fourth inner side surface 304d. The second inner surface 302b faces the first inner surface 302a. The first inner side surface 304a is between the first inner surface 302a and the second inner surface 302b. The second inner side surface 304b faces the first inner side surface 304a. The third inner side surface 304c is between the first inner side surface 304a and the second inner side surface 304b. The fourth inner side surface 304d faces the third inner side surface 304c. The case 300 has a height (the Z direction in the drawing) between the first inner surface 302a and the second inner surface 302b, has a length (the X direction in the drawing) between the first inner side surface 304a and the second inner side surface 304b, and has a width (the Y direction in the drawing) between the third inner side surface 304c and the fourth inner side surface 304d.

The plurality of battery cells 10 is accommodated in the case 300 such that the first lead terminal 210 and the second lead terminal 220 of each battery cell 10 face the first inner side surface 304a of the case 300.

In the example illustrated in FIGS. 10 and 11, even if the first inner side surface 304a of the case 300 and the first lead terminal 210 collide against each other due to impact on the battery pack 20 and the first lead terminal 210 receives the impact, the force transmitted from the first lead terminal 210 to the internal member of each battery cell 10 can be lessened by the bent portion of the first lead terminal 210 as described above. Accordingly, it is possible to restrain piercing of the first lead terminal 210 into the internal member of each battery cell 10. Similarly, even if the first inner side surface 304a of the case 300 and the second lead terminal 220 collide against each other due to impact on the battery pack 20 and the second lead terminal 220 receives the impact, the force transmitted from the second lead terminal 220 to the internal member of each battery cell 10 can be lessened by the bent portion of the second lead terminal 220 as described above. Accordingly, it is possible to restrain piercing of the second lead terminal 220 into the internal member of each battery cell 10.

The battery pack 20 further includes a plurality of buffer members 310. Each buffer member 310 separates the adjacent first lead terminals 210 from each other and separates the adjacent second lead terminals 220 from each other. In the example illustrated in FIG. 11, each buffer member 310 extends from the first lead terminal 210 to the second lead terminal 220. The buffer member 310 is made of a material (for example, rubber or sponge) capable of lessening impact received by the battery pack 20. Accordingly, the buffer member 310 can lessen the impact received by the first lead terminal 210 and the second lead terminal 220.

In the example illustrated in FIG. 10, spaces 312 are defined between sets of adjacent exterior materials 140 and the buffer members 310. The spaces 312 function as regions for buffering impact received by the battery pack 20. Furthermore, the spaces 312 function as regions into which the buffer members 310 are to be entered when the buffer members 310 have moved due to the impact received by the battery pack 20. If the buffer members 310 move toward the exterior materials 140 without the spaces 312, there is a concern that the battery cells 10 (for example, FIGS. 2 and 3) in the exterior materials 140 may be damaged by the buffer members 310. In the example illustrated in FIG. 10, a damage on the battery cells 10 (for example, FIGS. 2 and 3) in the exterior materials 140 due to movement of the buffer members 310 can be reduced by the spaces 312.

The battery pack 20 may be mounted in a flying object (for example, a drone). In this case, the battery pack 20 may receive large impact due to dropping. Even if the battery pack 20 receives such large impact, it is possible to restrain piercing of the first electrode 110 and the second lead terminal 220 into the internal member of the battery cell 10, according to this embodiment.

Although the embodiments of the present invention have been described above with reference to the drawings, these are merely examples of the present invention, and various configurations other than the aforementioned configurations can be employed.

The present application claims the priority based on Japanese Patent Application No. 2018-013971 filed Jan. 30, 2018, the entire disclosure of which will be incorporated herein.

1. A battery cell comprising:
a laminated body comprising a first electrode, a second electrode, and a separator, the laminated body comprising a first surface, a second surface opposite to the first surface, and a first side surface between the first surface and the second surface; and
a first lead terminal comprising a first end and a second end opposite to the first end, the first end being positioned such that the first end faces the first side surface of the laminated body,
wherein the second end of the first lead terminal projects obliquely with respect to the first side surface of the laminated body.

2. The battery cell according to claim 1, further comprising:
an exterior material wrapping the laminated body,
wherein the exterior material seals a part of the first lead terminal such that the first end of the first lead terminal is positioned inside the exterior material and the second end of the first lead terminal is exposed to the outside of the exterior material, and
the first lead terminal has a bent portion at the part of the first lead terminal.

3. The battery cell according to claim 2,
wherein the exterior material has a first side intersecting with the first lead terminal, and
the first side of the exterior material has a notch on at least one of both sides of the first lead terminal.

4. The battery cell according to claim 1, further comprising:
a second lead terminal comprising a first end and a second end opposite to the first end,
wherein the second lead terminal is positioned such that the first end of the second lead terminal faces the first side surface of the laminated body, and
the second end of the second lead terminal projects obliquely with respect to the first side surface of the laminated body.

5. The battery cell according to claim 1, further comprising:
a second lead terminal comprising a first end and a second end opposite to the first end,
wherein the laminated body has a second side surface opposite to the first side surface,
the second lead terminal is positioned such that the first end of the second lead terminal faces the second side surface of the laminated body, and
the second end of the first lead terminal projects obliquely with respect to the second side surface of the laminated body.

6. A battery pack comprising:
a case; and
a battery cell accommodated in the case;
wherein the battery cell comprises:
a laminated body comprising a first electrode, a second electrode, and a separator, the laminated body comprising a first surface, a second surface opposite to the first surface, and a first side surface between the first surface and the second surface, and
a first lead terminal comprising a first end and a second end opposite to the first end, the first end being positioned such that the first end faces the first side surface of the laminated body, and
the second end of the first lead terminal projects obliquely with respect to the first side surface of the laminated body.
